(19) United States
(12) Patent Application Publication
(10) Pub. No.: US 2005/0079264 A1
(43) Pub. Date: Apr. 14, 2005

(54) Tables delivery system

(76) Inventors: Wayne Federick Leech, Manukau City, Auckland (NZ); Majid Razzak, Auckland (NZ); Patrick Joseph Silcock, Dunedin (NZ)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/491,727

(22) PCT Filed: Oct. 9, 2002
(86) PCT No.: PCT/NZ02/00207

(30) Foreign Application Priority Data
Oct. 9, 2001 (NZ) 513416
Jul. 9, 2002 (NZ) 521859

(51) Int. Cl. A21D 10/00

(52) U.S. Cl. 426/549

(57) ABSTRACT

An edible dough is described for use in an oral delivery method for administering a medicament to an animal. The dough is comprised of flour, soluble fibre, either oil or water and an optional range of additional ingredients thus forming a dough that can be moulded around a medicament. A key improvement of the present invention dough is that it has extensibility characteristics that allow it to form a homogeneous mass with the medicament. As a result of the improved extensibility, it is very difficult for an animal to separate out the medicament from the dough thus allowing easy administration of medicaments such as pills and tablets to an animal.

### TECHNICAL FIELD

The present invention relates to a dough wrap for a pill, tablet or capsule. More specifically, a dough is moulded around a pill before administration to an animal.

### BACKGROUND ART

A common problem encountered by many pet owners in treating a pet's illness or infection is the actual administration of the medication, especially via the oral route. Many animals refuse to take medication voluntarily due to the medication's unusual odour, taste, and/or texture.

Often drastic, and consequently very difficult, measures must be taken to get the reluctant animal to take the medication, such as physically restraining the animal and forcing the medication down the animal's throat. Such methods are unpleasant for both the animal and the one having to administer the medication, the latter of whom may get scratched or bitten in the process.

It is believed that the primary way of administering veterinary medications to reluctant animals via oral administration is by first embedding the medication in food, such as a piece of cheese, peanut butter, or meat (e.g. hot dog). Not only is this a messy process, especially with peanut butter, but there is a significant risk that the medication will fall out of the food.

It is therefore desirable to have an oral delivery system that allows for the easy administration of medications to veterinary patients, wherein the delivery system ensures that the total dose is delivered without being lost prior to administration, is edible, and has an acceptable texture as well as a pleasant taste and odour so as to mask the odour and/or taste of the medication contained therein.

Three patents (U.S. Pat. No. 5,853,757, U.S. Pat. No. 5,674,515 and U.S. Pat. No. 6,143,316) have all developed the concept to some extent. Each invention takes a carrier, tube or pouch with a chamber, inside which the medication is placed. The tube is edible and in the main embodiments of each invention, the tube end can be deformed.

The above formulations do however have the problem of longevity of the carrier material and storage problems. The carrier materials need to be refrigerated to be kept fresh and stable.

Also, each of the above methods described also relates to the selling of the carrier in a tube or pouch shape. This limits the options in terms of tablet or capsule sizes and shapes that the tube or pouch can take.

A further problem with carrier tubes and pouches is that the animal is able to separate the tube/pouch from the pill. To the frustration of pet owners, the animal then eats the tube/pouch and spits out the pill uneaten.

It is therefore desirable to have a formulation for an oral delivery system that allows for the easy administration of medications to veterinary patients where the delivery carrier is stable at room temperature and can be moulded to the exact shape of the medication to be administered.

It is a further object of the present invention to provide a formulation for an oral delivery system that allows for the easy administration of medications to veterinary patients where the delivery carrier has extensibility characteristics that allow it to form a homogeneous mass around a pill that is difficult for an animal to separate.

It is a further objection of the present invention to address the foregoing problems or at least to provide the public with a useful choice.

For the purposes of the specification the term ‘dough’ may include other similar types of deformable product such as a putty. This is not, however, intended to be seen as limiting.

For the purposes of the specification, the invention is described in connection with administration of a ‘pill’. It will be appreciated that the term ‘pill’ can include one or more medicinal delivery devices, each selected from the group of a capsule, a tablet, a liquid and a combination thereof. It is not intended to be seen as limiting.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning−i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided an edible dough for use in an oral delivery method;
wherein the dough comprises at least one flour, at least one soluble fibre, at least one oil, and at least one other pharmaceutically and/or physiologically acceptable agent; and,
wherein the dough is capable of being moulded around a medicament selected from the group including: a pill; pills; a capsule; capsules; a tablet; tablets; a liquid; and combinations thereof; and,
characterised in that the dough has extensibility characteristics that allow it to form a homogeneous mass with the medicament.

According to a further aspect of the present invention there is provided an edible dough for use in an oral delivery method;
wherein the dough comprises at least one flour, at least one soluble fibre, water, and at least one other pharmaceutically and/or physiologically acceptable agent; and,
wherein the dough is capable of being moulded around a medicament selected from the group including: a pill; pills; a capsule; capsules; a tablet; tablets; a liquid; and combinations thereof; and,
characterised in that the dough has extensibility characteristics that allow it to form a homogeneous mass with the medicament.

An improved result has been achieved with the dough of the present invention wherein the dough has extensibility characteristics that allow it to form a homogenous mass with the medicinal delivery system.

It is understood by the applicants that this is due to a combination of soluble fibre, flour and either oil or water. The mixture forms a dough with desirable extensibility characteristics allowing it to form a homogeneous mass with the pill or other medicinal delivery means.

For the purposes of the specification, the word extensibility refers to the ability of the dough to be malleable, mouldable and its ability to form a film between the medicinal carrier and the dough.

In the embodiment where a pill for example is used to feed a medicament to an animal, the dough moulds around the pill and forms a film between the pill and the dough. This film is very difficult for the animal to break down and hence separate the pill from the dough. As a result this improved dough makes a significant improvement on existing carrier methods.

A further advantage of the extensibility characteristics includes a very malleable dough which can be readily stretched and deformed to a variety of shapes without loosing the ability to form a homogenous mass around a particular medicament.

A further advantage of the present invention is that the mixture has a low water activity, with estimates of this activity being between 0.4 and 0.6. This activity is well below that required for microbial growth. As a result the product is microbiologically stable at room temperature.

In the preferred embodiment, the pill dough includes flavouring agent and/or flavouring enhancer that is attractive to animals. It will be appreciated that a variety of flavouring agents and enhancers are possible including but not limited to beef, lamb, chicken, seafood; bacon; amino acids; or combinations thereof.

In preferred embodiments, the flavouring and if present, flavouring enhancer is included at a level of 0.45 wt % to 1.5 wt % of the total mixture.

Preferably the dough can be used for any animal. More preferably the dough is useful for domestic pets such as cats and dogs.

In preferred embodiments, the flour used is selected from the group including: urid flour; wheat flour; corn flour; rice flour and combinations thereof. The type and combination of flours vary depending on the degree of softness required. This is due to the different water absorption properties of flour types.

In preferred embodiments, soluble fibre materials are selected from the group including: pectins, gums, beta-glucans; starches; glutens; and combinations thereof. Still further sources of soluble fibre include guar gums, agar, vegetables, fruits, rice bran and pulps.

In one embodiment oil is used to form the dough. Preferably, an oil or oils are selected from the group including: peanut oil; sunflower oil; and combinations thereof.

Preferably said pharmaceutically and physiologically acceptable agents are selected from the group including: at least one preservative; sodium chloride; water; at least one inorganic filler; propylene glycol; polyethylene glycol; at least one emulsifier; at least one fat compound; at least one colouring; at least one soluble fibre; and combinations thereof.

In preferred embodiments, a preservative or preservatives are selected from the group including: benzyl alcohol; parabens; sorbates; benzoates; and combinations thereof. Said preservatives aid in microbial stability of the dough

In preferred embodiments, an inorganic filler or fillers are selected from the group including: silicates; sulphates; carbonates; metal oxides; and combinations thereof. It has been found by the applicant that said inorganic fillers aid in adjustingthe colour of the dough and in particular altering the translucent nature of the dough

In preferred embodiments, an emulsifier or emulsifiers and fat are selected from the group including: ethoxylates; gums; sorbitans; castor oil derivatives; solid fats; monostearates; and combinations thereof. By adding emulsifiers, the tackiness or stickiness of the dough can be altered. In addition, said emulsifiers act as additional fillers for the dough.

In a further embodiment of the present invention, the dough contains glycerol. Glycerol is a humectant and plasticiser in the current invention. Its inclusion aids in the extensibility properties of the dough.

In one preferred embodiment, the dough includes: urid flour; sodium methyl paraben; sodium propyl paraben; benzyl alcohol; propylene glycol; oil; and beef flavouring. More preferably, the combination includes: 60 to 65 wt % urid flour; 0.05 to 0.15 wt % sodium methyl paraben; 0.01 to 0.02 wt % sodium propyl paraben; 0.5 to 0.7 wt % benzyl alcohol; 6.0 to 6.5 wt % propylene glycol; 28 to 35 wt % peanut oil or sunflower oil, or a combination thereof; and 0.2 to 1.0 wt % beef flavouring.

In another preferred embodiment, the dough also includes: sodium chloride and water. Most preferably the combination includes: 60 to 65 wt % urid flour; 0.05 to 0.15 wt % sodium methyl paraben; 0.01 to 0.02 wt % sodium propyl paraben; 0.5 to 0.7 wt % benzyl alcohol; 6.0 to 6.5 wt % propylene glycol; 28 to 3 5 wt % peanut oil or sunflower oil, or a combination thereof; 0.2 to 0.4 wt % sodium chloride in the form of a powder; 0.1 to 0.2 wt % of water; and 0.2 to 1.0 wt % beef flavouring.

In a further alternative embodiment, the dough includes: wheat flour; inorganic filler, preservative; glycerol; water; emulsifiers and fats; flavouring; colouring; and soluble fibre. More preferably, the combination includes: 5 to 45 wt % wheat flour; 1.5 to 3.0 wt % inorganic filler, 0.1 to 0.3 wt % preservative; 20 to 30 wt % glycerol; 9 to 13 wt % water; 5 to 15 wt % emulsifiers and fats; 1 to 1.5 wt % flavouring; 0.2 to 1.0 wt % colouring; and 10 to 40 wt % soluble fibre.

In a further alternative embodiment, the dough includes: wheat flour, rice flour; soluble fibre; glycerol; water; inorganic fillers; emulsifiers; flavourings and flavour enhancers; preservatives and fat. Most preferably the combination includes: 5 to 45% wheat flour or rice or combinations thereof; 10 to 40 wt % soluble fibre; 20 to 30 wt % glycerol; 9 to 13 wt % water; 1.5 to 3.0 wt % inorganic fillers; 5 to 20 wt % emulsifiers and fats; 1 to 1.5 wt % flavouring and flavouring enhancer; 0.1 to 0.3 wt % preservative.

In an alternative embodiment, the dough, is dusted with additional ingredients selected from the group including: a flour; flours, sodium chloride; flavouring; or combinations thereof.

In one embodiment, the dough is sold as a block wrapped in suitable packaging, either in combination with or without the pills. Preferably, the dough is supplied in a packaging blister with small portions of the dough in each blister.

Preferably the medicament is a pill. Examples include worm tablets and antibiotic pills or capsules. A further advantage is that the pill dough can accommodate any shape of pill or pill combinations.

In preferred embodiments, the dough is stable (microbial, colour, odour and extensibility) at room temperature and does not need refrigeration.

According to a further aspect of the present invention there is provided an oral delivery method for delivering a medicament to an animal wherein;
(a) an edible dough substantially as described above is moulded around a medicament and;
(b) the moulded dough and medicament are administered to the animal; characterised in that the dough has extensibility properties such that the medicament and dough form a homogeneous mass that the animal cannot separate.

It can be seen from the above disclosure that the invention is designed to overcome the aversion that most animals have to taking tablets. A piece of the dough is wrapped around the tablet which is then fed to the animal.

One advantage of the deformable dough is that it can be used in an oral delivery method that allows for the easy administration of medications to animals.

In addition the dough has extensibility characteristics allowing it to form a homogenous mass with the medication, thus making it difficult for the animal to separate out the pill.

Further improvements are the fact that the dough is stable at room temperature in terms of microbiology, colour, odour and extensibility.

### BEST MODES FOR CARRYING OUT THE INVENTION

In the present invention, the term ‘dough’ is used however this may include other similar types of product such as putties. Similarly, for the purposes of this specification, the invention is described by way of administration of a ‘pill’. The dough can also be used to mask the taste of a capsule, tablet or other types of medicament and the term ‘pill’ is not intended to be limiting.

### EXAMPLE 1

In one preferred embodiment, two formulations utilising a flour/oil mixture are prepared:

| | Formulation 1 | Formulation 2 |
|---|---|---|
| Ingredients | Weight (%) | Weight (%) |
| Urid flour | 60.45 | 61.53 |
| Sodium methyl paraben | 0.1 | 0.1 |
| Sodium propyl paraben | 0.012 | 0.012 |
| Benzyl alcohol | 0.6 | 0.6 |
| Propylene glycol | 6.04 | 6.15 |
| Peanut oil or sunflower oil or | 32.3 | 30.7 |
| a mixture | | |
| Sodium chloride (powder) | — | 0.31 |
| Water | — | 0.15 |
| Beef flavour | 0.5 | 0.45 |
| Total | 100% | 100% |

Procedure—Formulation 1

1. Mix urid flour, sodium methyl paraben, sodium propyl paraben and benzyl alcohol.

2. Add peanut oil/sunflower oil and mix well.

3. Add propylene glycol and mix well.

4. Add the balance of peanut oil/sunflower oil in increments and mix well to get the dough.

5. Add beef flavour to the above dough and mix well.

Procedure—Formulation 2

1. Mix Urid flour, sodium methyl paraben, sodium propyl paraben and benzyl alcohol.

2. Add peanut oil/sunflower oil and mix well.

3. Add propylene glycol and mix well.

4. Add more peanut oil/sunflower oil in increments and mix well to get the dough.

5. Add sodium chloride and mix well.

6. Add Peanut oil/sunflower oil and mix well.

7. Add water and mix well.

8. Add beef flavour to the above dough and mix well to get a uniform dough.

The dough is sold as either a block from which the customer breaks off a portion of dough or as a blister pack of pre-sized small blocks or lumps.

In use, the dough portion is moulded around the medicament and formed into a homogeneous mass. The dough and medicament combination is then administered to the animal. As the dough and medicament form a complete mass, the animal is unable to separate the dough from the medicament.

### EXAMPLE 2

In an alternative embodiment another formulation utilising a flour, glycerol, soluble fibre and water mixture is prepared:

| | Formulation 3 |
|---|---|
| Ingredients | Weight (%) |
| wheat flour | 38.3 |
| inorganic filler | 2.0 |
| preservative | 0.2 |
| glycerol | 25.0 |
| water | 11.0 |
| emulsifier and fat | 9.0 |
| flavour | 1.5 |
| colour | 0.5 |
| soluble fibre | 12.5 |
| Total | 100.0% |

Procedure—Formulation 3

1. The flour, inorganic filler and soluble fibre are blended together.

2. The preservative, flavours and colours are dispersed in the water.

3. The emulsifier and fat are melted, then mixed with the glycerol, and then added to the water.

4. The liquid of step 3 is slowly added to the powders while the mixer is running.

5. The mixture from step 4 is removed from the mixer, sheeted and dusted with rice flour.

6. The sheets are cooled until they are firm enough to be cut.

7. The sheets are cut and individual pieces dusted to prevent sticking.

8. The pieces are kept cold to maintain shape until they are packed off.

The dough is then sold in a similar form as formulations 1 and 2 above. In addition, the method of administration is the same, i.e. the pill is wrapped in the dough and the dough and pill are administered to the animal. As this formulation has similar extensibility properties to that of Example 1, the animal is unable to separate out the medicament from the dough.

### EXAMPLE 3

In a further alternative to formulation 3, an alternative formulation 4 is prepared utilising a different mix of flour, glycerol, soluble fibre and water as follows:

| | Formulation 4 |
|---|---|
| Ingredients | Weight % |
| flour | 13.68 wt % |
| soluble fibre | 31.17 wt % |
| inorganic | 2.49 wt % |
| glycerol | 23.45 wt % |
| water | 10.64 wt % |
| emulsifier | 12.4 wt % |
| flavour | 1.35 wt % |
| preservative | 0.21 wt % |
| fat | 4.62 wt % |

Procedure—Formulation 4

1. Mix the soluble fibre, flour, inorganic fillers together in a mixer;

2. Combine the fat and emulsifier together;

3. Add the glycerol to the mixture of step 2;

4. Mix together the water, flavours and preservatives;

5. Add the water from step 4 to the fat mixture of step 3;

6. Slowly add the water fat mixture of step 5 to the dry ingredients in step 1;

7. Once mixed remove and cut into sheets.

The mix can be dusted with additional flour, sodium chloride, and/or more flavouring if required.

The dough is then sold in a similar form to formulations 1, 2 and 3 above. In addition the method of administration is the same, i.e. the medicament is moulded in the dough and the dough and medicament are administered to the animal.

Aspects of the present invention have been described by way of example only and it should be appreciated that modifications and additions may be made thereto without departing from the scope thereof as defined in the appended claims.

1. An edible dough for use in an oral delivery method;
wherein the dough comprises at least one flour; at least one soluble fibre including at least one gum; and at least one other pharmaceutically and/or physiologically acceptable agent including at least glycerol; and,
wherein the dough is capable of being moulded around a medicament selected from the group including: a pill; pills; a capsule; capsules; a tablet; tablets; and combinations thereof; and further characterised in that the dough has extensibility characteristics that allow it to form a film with the medicament.

2. An edible dough as claimed in claim 1 wherein flour is selected from the group consisting of: urid flour; wheat flour; corn flour; rice flour; and combinations thereof.

3. An edible dough as claimed in claim 1 wherein soluble fibre is at least one gum in combination with compounds selected from the group consisting of: pectins, beta-glucans; starches; glutens; guar gums, agar, vegetables, fruits, rice bran; pulps; and combinations thereof.

4. An edible dough as claimed in claim 1 wherein pharmaceutically and physiologically acceptable agents include glycerol with other compounds selected from the group consisting of: at least one preservative compound; sodium chloride; water; at least one inorganic filler; propylene glycol; polyethylene glycol; at least one emulsifier; at least one fat compound; at least one colouring; at least one soluble fibre; and combinations thereof.

5. An edible dough as claimed in claim 1 wherein preservative compounds are selected from the group consisting of: benzyl alcohol; parabens; sorbates; benzoates; and combinations thereof.

6. An edible dough as claimed in claim 1 wherein inorganic filler compounds are selected from the group consisting of: silicates; sulphates; carbonates; metal oxides; and combinations thereof.

7. An edible dough as claimed in claim 1 wherein the or each emulsifier and fat is selected from the group consisting of: ethoxylates; gums; sorbitans; castor oil derivatives; solid fats; monostearates; and combinations thereof.

8. An edible dough as claimed in claim 1 wherein the dough further includes oil selected from the group including: peanut oil; sunflower oil; or combinations thereof.

9. An edible dough as claimed in claim 1 that includes a flavouring that is attractive to animals.

10. An edible dough as claimed in claim 9 wherein the flavouring is selected from the group consisting of: beef; lamb; chicken; seafood; bacon; amino acids; extracts of thereof; and combinations thereof.

11. An edible dough as claimed in either claim 9 wherein the flavouring is included in an amount from 0.45 wt % to 1.5 wt % by weight of the total mixture.

12. An edible dough as claimed in claim 1 wherein the animal is a domestic pet.

13. An edible dough for use in an oral delivery method, wherein the dough includes: rice flour, wheat flour, acacia gum, wheat gluten, unmodified corn starch, hydrogenated coconut oil, water, glycerine, calcium carbonate, titanium dioxide, sodium metabisulphate, beef flavouring, smoke flavouring, caramel colouring, and,
wherein the dough is characterised in that the dough has extensibility characteristics that allow it to form a film with a medicament.

14. An edible dough as claimed in claim 13 wherein the dough is dusted with additional ingredients selected from the group consisting of: a flour; flours, sodium chloride; flavouring; or combinations thereof.

15. An edible dough as claimed in claim 13 wherein the dough is microbiologically stable at room temperature.

16. A product incorporating a packaged block of dough as claimed in claim 13.

17. A product incorporating dough as claimed in claim 1, wherein the dough is in a blister packet with a small portion of the dough in each blister.

18. An oral delivery method for delivering a medicament to an animal wherein;
(a) an edible dough as claimed in claim 1 is moulded around a medicament and;
(b) the moulded dough and medicament are administered to the animal; and,
characterised in that the dough has extensibility properties such that the medicament and dough form a film between them that the animal cannot separate.

19-21. (Cancelled)
